(19) United States
(12) Patent Application Publication
(10) Pub. No.: US 2025/0246044 A1
(43) Pub. Date: Jul. 31, 2025

(54) PATRON VERIFICATION SYSTEMS AND METHODS

(71) Applicant: Primero Games, LLC, Norcross, GA (US)

(72) Inventors: Michael M. Macke, Duluth, GA (US); Barry W. Rutherford, Duluth, GA (US); Mark C. Nizdil, Duluth, GA (US)

(21) Appl. No.: 18/427,096

(22) Filed: Jan. 30, 2024

(51) Int. Cl. G07F 17/32

(52) U.S. Cl. CPC G07F 17/3239; G07F 17/3206; G07F 17/3241; G07F 17/3253; G07F 17/3258; G07F 17/329

(57) ABSTRACT

The gaming device can generate an outcome for a wagering game. The outcome can include multiple indicia or symbols positioned on a pay line. The gaming device can determine that a particular combination of indicia are positioned on a pay line. In response, the gaming device can determine a property associated with the current patron. The gaming device can determine if the property meets or exceeds a predetermined threshold. In response to the property meeting or exceeding the threshold, the gaming device can provide a lottery ticket to the current patron. In response to the property failing to meet the threshold, the gaming device can provide a prize.

### TECHNICAL FIELD

The present systems and processes relate to utilizing computing technology to analyze a patron to verify patron eligibility.

### BACKGROUND

Gaming systems and devices can require patron verification prior to allowing the patron to cash out. For example, a patron may be required to verify that their age meets or exceeds a minimum age threshold prior to cashing out. Age verification can require an attendant or cashier to check a patron's age, which can be time-consuming and costly. Additionally, patrons may be discouraged from placing bets on gaming devices with age restrictions due to the limited payout methods. Therefore, there is a long-felt but unresolved need for gaming technology to facilitate patron verification without the use of an attendant or cashier.

### BRIEF SUMMARY OF THE DISCLOSURE

Aspects of the present disclosure generally relate to patron verification for wagering games. A gaming device can require patron verification prior to cashing out the patron. For example, a gaming device can restrict payouts to patrons with an age below a predetermined threshold. As another example, a gaming device can require a patron to verify their identity prior to cashing out. In response to receiving a request from the patron to cash out, the gaming device can prompt the patron to complete the patron verification. During patron verification, the gaming device can determine a particular property associated with the current patron (e.g., the patron's age, identity). The gaming device can determine whether the particular property meets or exceeds a predetermined threshold.

The gaming system can provide multiple processes for patron verification that can be combined or supplement one another. The gaming device can scan the current patron's identification and verify the identification's authenticity. For example, the gaming device can verify the identification with the identification's issuer. As another example, the gaming device can verify the identification's authenticity based on data included in the identification's barcode or scannable code. The gaming device can determine a property associated with the patron based on the scanned identification.

The gaming device can transmit a request for identity data to the current patron's mobile device. The mobile device can prompt the patron to accept the request and transmit the payload to the gaming device. The gaming device can decrypt the payload and extract the identity data to determine the property.

The gaming device can capture an image of the current patron and identify the current patron's face in the image. The gaming device can apply a machine learning algorithm to the image to predict the particular property. The gaming device can compare the image to the current patron's scanned identification. The gaming device can determine the property based on the comparison.

In response to successfully completing patron verification, the gaming device can dispense a lottery ticket. The gaming device or gaming system can request an identifier from a lottery system and print a lottery ticket. In response to successful patron verification, the gaming device can dispense the lottery ticket. If patron verification fails, the gaming device can dispense a prize.

The above and further features of the disclosed systems and methods will be recognized from the following detailed descriptions and drawings of various embodiments.

### BRIEF DESCRIPTION OF THE FIGURES

The accompanying drawings illustrate one or more embodiments and/or

aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an exemplary patron verification system according to various embodiments of the present disclosure.

FIG. 2 illustrates an exemplary networked environment according to various embodiments of the present disclosure.

FIG. 3 illustrates an exemplary overall process for the disclosed system according to various embodiments of the present disclosure.

FIG. 4 illustrates an exemplary patron verification process according to various embodiments of the present disclosure.

FIG. 5 illustrates an exemplary patron verification process according to various embodiments of the present disclosure.

FIG. 6A illustrates an exemplary patron verification process according to various embodiments of the present disclosure.

FIG. 6B illustrates an exemplary patron verification process according to various embodiments of the present disclosure.

FIG. 6C illustrates an exemplary patron verification process according to various embodiments of the present disclosure.

FIG. 7 illustrates an exemplary lottery ticket generation process according to various embodiments of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Exemplary Embodiments

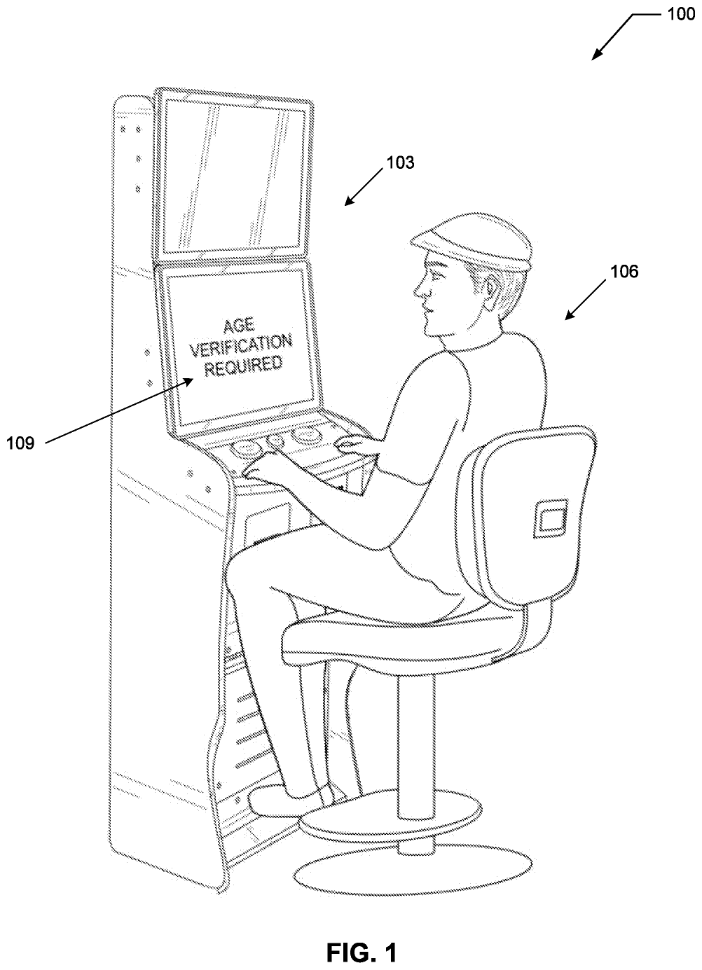

Referring now to the figures, for the purposes of example and explanation of the fundamental processes and components of the disclosed systems and processes, reference is made to FIG. 1, which illustrates the patron verification system 100. The system 100 can include a gaming device 103 being played by a patron 106. The gaming device 103 can facilitate play of and generate outcomes for a wagering game by the user/patron 106. After generating an outcome, the gaming device 103 can receive a request from the patron 106 to cash out the current credits. Prior to cashing out, the gaming device 103 can prompt the patron 106 to complete the patron verification via the display 109.

The gaming device 103 can verify the age or identity of the patron 106. For example, the gaming device 103 can be prohibited from cashing out if the patron 106 is below a predetermined age. As another example, the gaming device 103 can require that the patron 106 has a patron account for the gaming device 103. The gaming device 103 can verify the patron 106 by scanning an identification associated with the patron 106. The gaming device 103 can verify the patron 106 via a mobile device associated with the patron 106. The gaming device 103 can verify the patron 106 with an image of the patron 106.

If the gaming device 103 fails to complete the patron verification, the gaming device 103 can dispense a prize rather than cash out the current credits. If the gaming device 103 successfully complete the patron verification, the gaming device 103 can cash out the patron 106. The gaming device 103 can provide a voucher for the current credits or a lottery ticket.

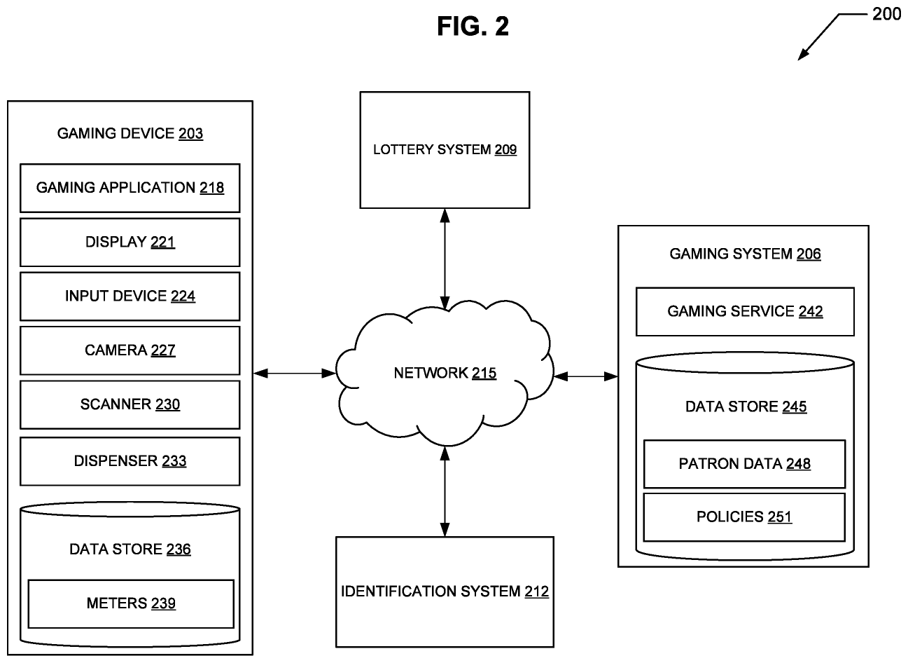

Referring now to FIG. 2, shown is an exemplary networked environment 200 for the patron verification system according to various embodiments of the present disclosure. As will be understood and appreciated, the exemplary networked environment 200 shown in FIG. 2 represents merely one approach or embodiment of the present system, and other aspects are used according to various embodiments of the present system. Exemplary networked environment 200 can include, but is not limited to, a gaming device 203, the gaming system 206, and the lottery system 209, and the identification system 212 connected over a network 215.

According to various embodiments, the gaming device 203 can include any device capable of accessing network 215 including, but not limited to, a computer, smartphone, tablets, or other device. The gaming device 203 can be a gaming cabinet, an amusement device, a slot machine, or other gaming device with a processor-based system such as a computer system. The gaming device 203 can include a processor and a data store 236. The gaming device 203 can include a display 221 on which various user interfaces can be rendered to allow users to configure, monitor, control, and command various functions of the gaming application 218. The gaming device 203 can include the input device 224 for a user to provide various inputs (e.g., selections, wagers, credentials). The input device 224 can include one or more buttons, touch screens including three-dimensional or pressure-based touch screens, camera, finger print scanners, accelerometer, retinal scanner, gyroscope, magnetometer, or other input devices. The input device 224 can also include a bill acceptor, a player tracking module, a ticket printer, or some other device. The gaming device 203 can include a camera 227 for capturing an image of a current patron placing bets at the gaming device 203. The gaming device 203 can include a scanner 230 for scanning an identification, via a bar code or other scannable code, or for scanning the identification as an image. The gaming device 203 can include a dispenser 233 for providing a prize or lottery ticket to the current patron. For example, the dispenser 233 can include a printer for printing lottery tickets.

In various embodiments, gaming device 203 can include multiple computing devices. Regardless, the gaming device 203 can include one or more processors and memory having instructions stored thereon that, when executed by the one or more processors, cause the gaming device 203 to perform one, some, or all of the actions, methods, steps, or functionalities provided herein. The gaming device 203 can be configured to execute various applications, such as the gaming application 218 and/or other applications. The gaming application 218 may be executed by the gaming device 203, for example, to access network content served up by the gaming system 206, and/or other servers, thereby rendering various user interfaces on the display 221. While the specification discusses various functionality as being performed by the gaming application 218 or the gaming service 242, it is understood that this functionality may be performed instead by the gaming service 242, gaming application 218, or both in coordination.

The gaming application 218 can receive bets and generate outcomes for wagering games. The gaming application 218 can modify the meters 239 stored in the data store 236, such as the current hand count meter, the coin-in meter, and the current credits meter. For example, the gaming application 218 can increase the current hand count meter each time a wagering game is played. The gaming application can increase or decrease the current credits meter based on the outcome of the wagering game. The gaming application 218 can receive a request to cash out (e.g., initiate a payout event) from the input device 224.

The gaming application 218 perform patron verification or determine that patron verification was previously completed. The gaming application 218 can determine if a particular property associated with the current patron (e.g., age) meets or exceeds a predetermined threshold. As another example, the gaming application 218 can require that the patron has a patron account associated with the gaming system 206 before performing a cash out or a particular payout event. The gaming application 218 can determine the appropriate method of patron verification based on one or more rules stored in the policies 251.

The gaming application 218 can use a combination of functions to complete the patron verification. The gaming application 218 can verify the authenticity of an identification with the identification system 212. The gaming application 218 can determine a property associated with the current patron (e.g., the current age or identity of the current patron) based on the information included on the identification. The gaming application 218 can generate and transmit a request for identity data from a mobile device associated with the current patron. The gaming application 218 can apply machine learning algorithms to an image of the current patron captured by the camera 227. The gaming application 218 can compared the captured image to an image from an identification.

The elements of the gaming system 206, the lottery system 209, and the identification system 212 can be provided via one or more computing devices that may be arranged, for example, in one or more server banks or computer banks or other arrangements. Such computing devices can be located in a single installation or may be distributed among many different geographical locations. For example, the gaming system 206, the lottery system 209, and the identification system 212 can include one or more computing devices that together may include a hosted computing resource, a grid computing resource, or any other distributed computing arrangement. In some cases, the gaming system 206, the lottery system 209, and the identification system 212 can correspond to an elastic computing resource where the allotted capacity of processing, network, storage, or other computing-related resources may vary over time. Regardless, the gaming system 206, the lottery system 209, and the identification system 212 can include one or more processors and memory having instructions stored thereon that, when executed by the one or more processors, cause the gaming system 206, the lottery system 209, and the identification system 212 to perform one, some, or all of the actions, methods, steps, or functionalities provided herein.

The gaming system 206 can include a gaming service 242 and the data store 245. The gaming service 242 can correspond to one or more software executables that can be executed by the gaming system 206 to perform the functionality described herein. Various data can be stored in the data store 245, including but not limited to, the patron data 248 and policies 251.

The gaming service 242 can communicate with multiple gaming devices 203. The gaming service 242 can receive and transmit messages and data with multiple gaming devices 203. The gaming service 242 can communication with both the lottery system 209 and the identification system 212. For example, the gaming service 242 can relay messages and requests between the lottery system 209 and the identification system 212 to assist with patron verification. The gaming service 242 can save the property determined by the gaming application 218 as a part of patron verification to the patron data 248. The gaming service 242 can associate the property with a particular patron account. The gaming service 242 can provide the gaming application 218 with one or more policies 251 for determining the appropriate patron verification methods.

The lottery system 209 can provide an identifier (e.g., a sequence of numbers) for a lottery ticket to the gaming application 218 and the gaming service 242. For example, the gaming application 218 or the gaming service 242 can transmit a request for an identifier to the lottery system 209. The lottery system 209 can respond to the request with the identifier.

The identification system 212 can be a third party database or service for identification data. For example, the identification system 212 can be a state database for verifying the authenticity of state-issued identification cards and driver's licenses. The identification system 212 can receive requests and transmit responses with both the gaming application 218 and the gaming service 242.

The network 215 can include, for example, the Internet, intranets, extranets, wide area networks (WANs), local area networks (LANs), wired networks, wireless networks, or other suitable networks, etc., or any combination of two or more such networks.

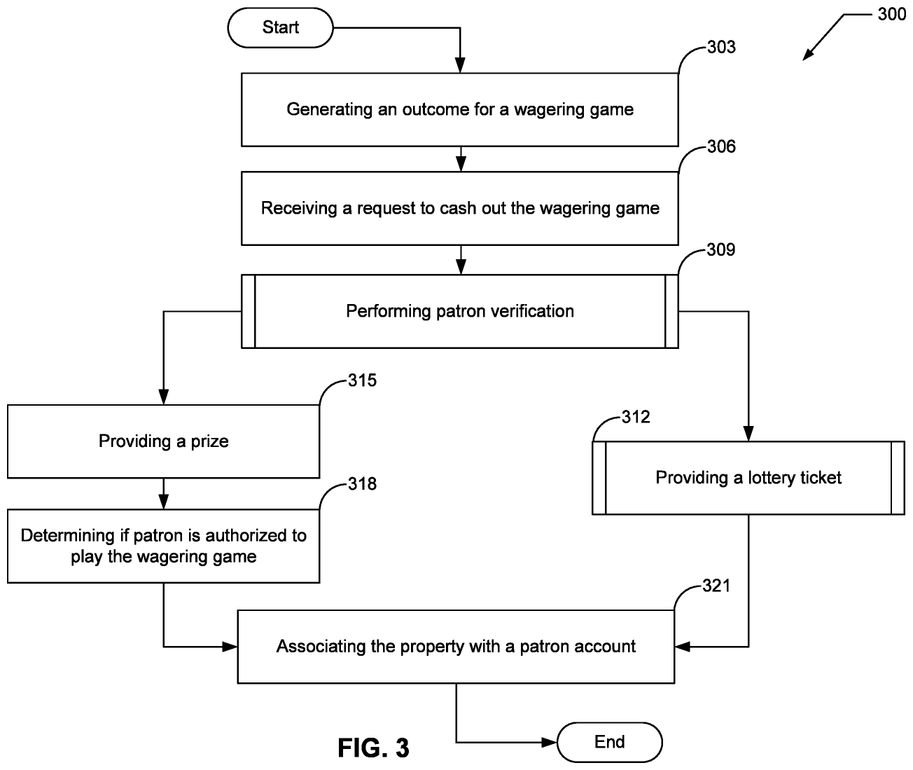

Referring now to FIG. 3, shown is an exemplary, high-level overview process 300 according to various embodiments of the present disclosure. As will be understood by one having ordinary skill in the art, the steps and processes shown in FIGS. 3-5 may operate concurrently and continuously, are generally asynchronous and independent, can be performed in part or in whole by a combination of one or more of the gaming device 203 and the gaming system 206, and are not necessarily performed in the order shown and various steps can be executed linearly or in parallel. Process 300 can be performed entirely, partially, or in coordination with the gaming application 218 and the gaming service 242.

At step 303, the process 300 can include generating an outcome for a wagering game. The gaming application 218 can generate the outcome for the wagering game. Generating the outcome can include receiving a bet (e.g., input) for the wagering game. Multiple bets can be received for multiple wagering games and multiple outcomes can be generated for the multiple wagering games. As an example, the gaming application 218 can iteratively receive a bet and generate an outcome for wagering games. After receiving the bet, an outcome can be generated for each wagering game and render the outcome on the display 221. In response to generating an outcome, the meters 239 can be modified. For example, the meters 239 can include, but are not limited to, current credits, coin-in, and hand count. The current credits can be increased or decreased based on the outcome of the wagering game. For example, if the outcome is a win, then the currents credits can increase based on the amount won during the wagering games. As another example, the hand count can increased regardless of the outcome of the wagering game.

At step 306, the process 300 can include receiving a request to cash out the wagering game. The gaming application 218 can receive the request to cash out the wagering game. The request to cash out can be received as an input from the patron via the input device 224. In some embodiments, the patron can request to cash out from an attendant or at a kiosk. The request to cash out can initiate a payout event, which can include, but is not limited to, paying out the amount of the current credits to the patron (e.g., as cash or as a voucher for an equivalent amount in cash), providing a lottery ticket to the patron, or providing a prize to the patron as discussed herein. The request to cash out and/or the payout event can trigger the patron verification at step 309.

Receiving the request to cash out can include determining that a particular combination of indicia (e.g., symbols) are positioned on a pay line of the gaming device 203. For example, when the gaming application 218 generates an outcome for a wagering game, the outcome can include the particular combination of indicia on a pay line. The particular combination of indicia can include hundreds or thousands of combinations of indicia and the gaming device 203 can include multiple pay lines. If the particular combination of indicia is determined to be positioned on a pay line, the gaming application 218 can determine the particular combination corresponds to a progressive jackpot and provide an award based on the progressive jackpot. Determining that the particular combination of indicia are positioned on the pay line can trigger the patron verification at step 309.

Receiving the request to cash out can include determining that the current credits is below a credit threshold. The credit threshold can include an amount of current credits necessary for allowing a cash out or a particular type of payout event. For example, if the current credits falls below a threshold, then providing a lottery ticket or a prize can be the only types of payout events permitted (e.g., paying out the amount of the current credits may be prohibited). Determining that the current credits is below the credit threshold can trigger the patron verification at step 309.

At step 309, the process 300 can include performing a patron verification. The gaming application 218 and/or gaming service 242 can perform the patron verification. The patron verification can include verifying a particular property associated with the current patron or determining that the particular property has been previously verified. The patron verification can include determining that the particular property associated with the current patron meets or exceeds a predetermined threshold. The particular property can include the identity of the patron, the current age of the patron, one or more biometric properties, and a patron account (e.g., user account associated with the patron). For example, the gaming application 218 can be prohibited from performing a cash out or a particular payout event if the patron is under a certain age (e.g., the legal age to play the wagering game in the jurisdiction). The gaming application 218 can determine if the particular property (e.g., the current age of the patron) meets or exceeds the predetermined threshold (e.g., the minimum age to allow for the wagering game to cash out; the minimum age to play the wagering game). As another example, the gaming application 218 can require that the patron's identity be verified before performing a cash out or a particular payout event. In some embodiments, rather than requiring the particular property to meet or exceed the predetermined threshold, the gaming application 218 can condition performing a cash out or a particular payout event on verifying proof of identify for the patron. As another example, the gaming application 218 can require that the patron has a patron account associated with the gaming system 206 before performing a cash out or a particular payout event. The gaming device 203 can determine that the particular property (e.g., the patron's name) is associated with a patron account.

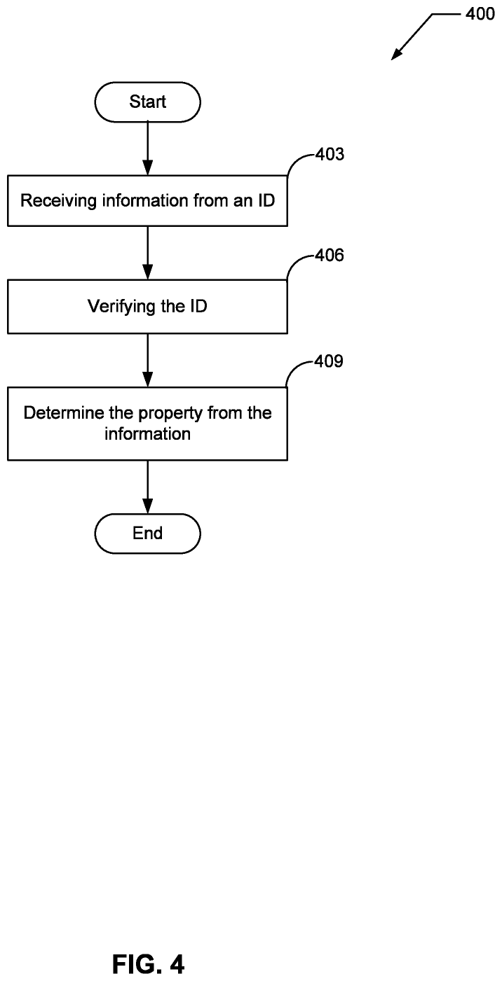

The gaming application 218 can determine the appropriate method of patron verification based on one or more rules stored in the policies 251. The patron verification can be performed in response to receiving a request to cash out, a particular payout event, a determination that the current credit value falls below the credit threshold, or a determination that the particular combination of indicia are positioned along the pay line. The patron verification is described further in reference to FIGS. 4-6. As will be understood, the processes illustrated by FIGS. 4-6 can replace or supplement step 309.

If the particular property associated with the patron has been previously verified, the gaming application 218 can determine that patron verification has been performed previously. If patron verification has been previously performed or completed, performing patron verification again can be unnecessary. To determine if patron verification has been performed previously, the gaming application 218 can authenticate the patron. The gaming application 218 can prompt the patron to provide credentials for a patron account associated with the gaming system 206. The gaming application 218 can authenticate the user via a player tracking module, a radio frequency identifier (RFID) reader, a card reader, a near field communication (NFC), such as Bluetooth circuitry, Wi-Fi circuitry, or other wireless antenna-based technology. In some embodiments, the patron can insert a patron tracking card into the gaming device 203 to authenticate the patron account. In another embodiment, the gaming device 203 can read a user identifier associated with the patron from using near field communication (NFC).

If the patron verification is successfully completed (e.g., the particular property is verified or determined to be verified, the particular property meets or exceeds a threshold), the process 300 can proceed to step 312. If patron verification is unsuccessful (e.g., the particular property is not verified, the particular property is determined to be not verified and is unable to be verified, the particular property is below a threshold), the process 300 can proceed to step 315.

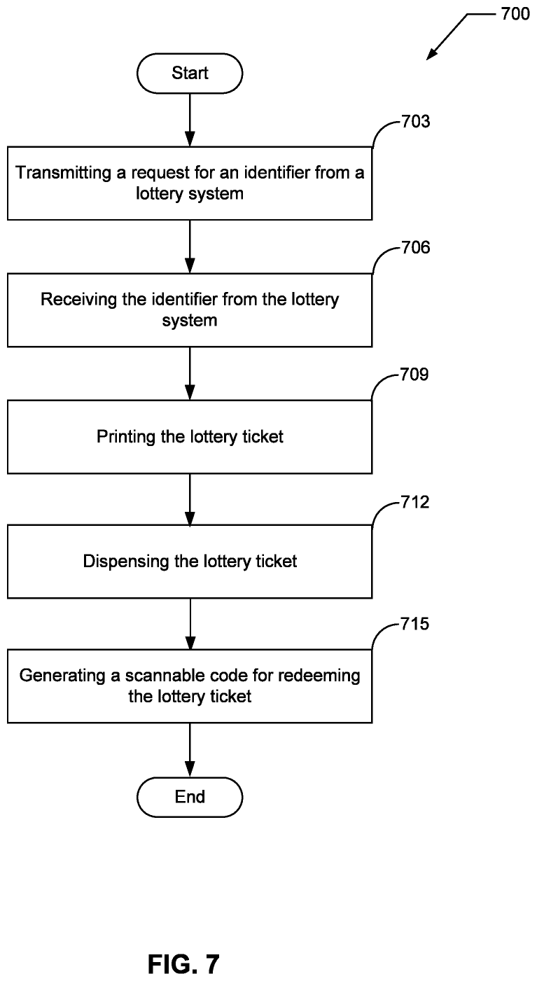

At step 312, the process 300 can include providing a lottery ticket. The gaming application 218 and the gaming device 203 can provide the lottery ticket to the current patron. The lottery ticket can be provided to the patron in response to the gaming application 218 successfully performing the patron verification (e.g., the particular property is verified or determined to be verified, the particular property meets or exceeds a threshold). The gaming application 218 and the gaming device 203 can generate, print, and dispense the lottery tickets. In some embodiments, the lottery tickets can be generated and printed offsite (e.g., not by the gaming application 218 and the gaming device 203) and stored in the gaming device 203. In this example, the gaming device 203 can dispense one of the lottery tickets to the patron. A particular lottery ticket can be provided as an award to a progressive jackpot (e.g., in response to the particular combination of indicia being positioned on the pay line). The lottery ticket can be a pull tab ticket, a scratch off lottery ticket, or a coin board lottery ticket. The lottery ticket can be a voucher for the amount of the current credits that a patron can cash in with a cashier or at a kiosk. Providing the lottery tickets is described further in reference to FIG. 7. As will be understood, the process illustrated by FIG. 7 can replace or supplement step 312.

At step 315, the process 300 can include providing a prize. The gaming application 218 and the gaming device 203 can provide a prize to the current patron. The prize can be provided to the patron in response to the gaming application 218 failing to successfully perform the patron verification (e.g., the particular property is not verified, the particular property is determined to be not verified and is unable to be verified, the particular property is below a threshold). The prize can be a toy or any small object capable of being dispensed from a gaming device 203. The prize can be a voucher for a different game. The prize can be dispensed to the current patron from the gaming device 203 via the dispenser 233.

At step 318, the process 300 can include determining if the current patron is authorized to play the wagering game. The gaming application 218 can determine if the current patron is authorized to play the wagering game. For example, the data store 245 can include policies 251. The policies can include rules relating patron verification. For example, underage patrons may be unauthorized to play the wagering game. If patron verification fails because the particular property (e.g., the patron's age) falls below the threshold (e.g., the minimum age required to play the wagering game), the patron can be unauthorized to play the wagering game. The gaming application 218 can apply the policies 251 to the particular property associated with the patron to determine if the patron is authorized to play the wagering game. If the patron is not authorized to play the wagering game, the gaming application 218 can restrict access to the wagering game by locking out the game, darkening the display 221, or transmitting a notification to an attendant.

At step 321, the process 300 can include associating the property with a patron account (e.g., user account) associated with the gaming system 206. The gaming application 218 can transmit the property and related metadata (e.g., an identifier for the patron account, results of patron verification, authorization to play the wagering game) to the gaming service 242 to be saved as the patron data 248. The property and related metadata can be associated with a patron account when saved as the patron data 248.

After step 321, the process 300 can end or return to step 303 to repeat. For example, the gaming application 218 can receive a request to cash out from a first patron. The first patron can be successfully verified at step 309 and the gaming device 203 can provide a lottery ticket to the first patron at step 312. After process 300 ending, the process 300 can begin again at step 303 and generate an outcome for the wagering game. The gaming application 218 can receive a request to cash out from a second patron. The gaming application 218 can determine that the current credits falls below the credit threshold. At step 309, the patron verification can fail and at step 315, the gaming device 203 can provide a prize to the second patron. The process 300 can end and start again each time a patron places a bet for a wagering game.

Referring now to FIG. 4, shown is an exemplary patron verification process 400 according to various embodiments of the present disclosure. Process 400 can be performed entirely, partially, or in coordination with the gaming device 203, the gaming application 218, and the gaming service 242. At step 403, the process 400 can include receiving information from an identification associated with the current patron. The identification can include a scannable device with a barcode or other scannable code. For example, the identification can include a driver's license, a government or work issued identification card, a passport, or any other acceptable identification. The gaming application 218 can receive information from an identification via the scanner 230. The scanner 230 can scan the identification by scanning the barcode or other scannable code included on the identification. The scanner 230 can scan the identification by scanning the identification as an image and performing character recognition on the image. After the scanner 230 scans the identification, the gaming application 218 can determine information included in the identification, including but not limited to, name, age, birthdate, issuer, expiration date, identification card number, and address.

At step 406, the process 400 can include verifying the identification. The gaming application 218 can verify the authenticity of the identification (e.g., the identification was issued by the proper agency and belongs to the patron). The gaming application 218 can verify the authenticity of the identification with or without communicating with the gaming service 242. For example, the gaming application 218 can transmit the information from the identification to the gaming service 242. The gaming service 242 can communicate with the identification system 212 to verify that the identification is authentic (e.g., issued by the proper agency and belongs to the patron). In one embodiment, the gaming application 218 can verify the identification based on the barcode or scannable code.

At step 409, the process 400 can include determining the property associated with the current patron from the information on the identification. The gaming application 218 can determine the property associated with the current patron from the information on the identification. For example, if the scanner 230 scans a barcode or scannable code from the identification, the code can include the information. As another example, the gaming application 218 can perform character recognition to determine the property. As discussed with reference to step 309, determining the property associated with the current patron can be patron verification. For example, the gaming application 218 can determine that the property (e.g., the current age of the current patron) compared to a threshold. In this example, the threshold can be a minimum age to play the wagering game. The gaming application 218 can determine that the age listed on the identification meets the threshold. In some embodiments, the gaming application 218 can determine that the age listed on the identification falls below a threshold and determine that patron verification has failed. As another example, the gaming application 218 can determine the property (e.g., the name of the current patron) and verify the identity of the current patron based on the information from the identification. The gaming application 218 can compare the property to a saved property associated with a patron account (e.g., comparing the name from the identification to the name associated with a patron account).

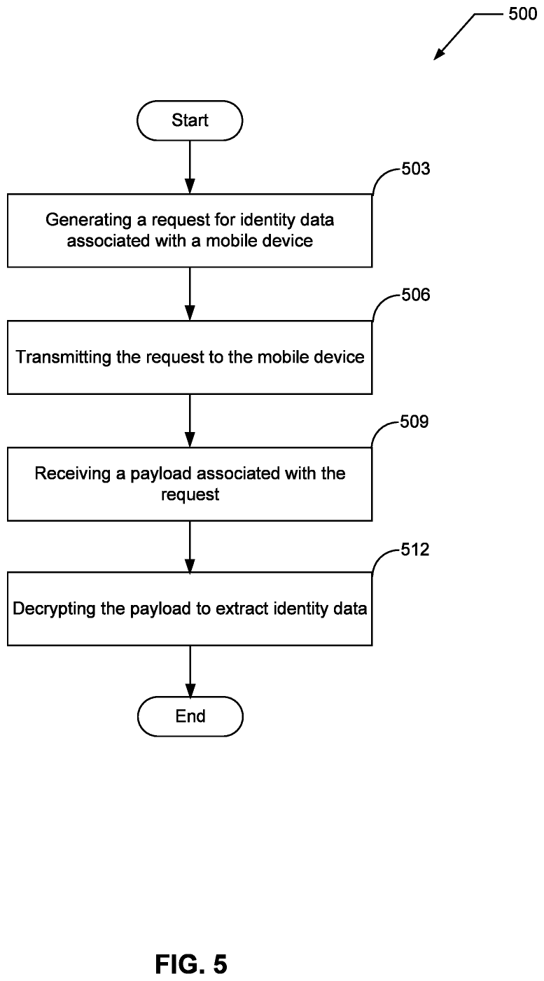

Referring now to FIG. 5, shown is an exemplary patron verification process 500 according to various embodiments of the present disclosure. Process 500 can be performed entirely, partially, or in coordination with the gaming device 203, the gaming application 218, and the gaming service 242. At step 503, the process 500 can include generating a request for identity data associated with a mobile device. The gaming application 218 can generate the request for identity data. The gaming application 218 can request identity data associated with the current patron, including but not limited to, the identity and current age of the patron. The gaming application 218 can request identity data included on the identification associated with the current patron. The gaming application 218 can request a binary response based on the property. For example, the gaming application 218 can request if the current patron's age meets or exceeds the threshold and the gaming application 218 can receive a true or false in response to the request. The request can include a nonce. The mobile device can be a mobile device of the current patron.

At step 506, the process 500 can include transmitting the request to the mobile device. The gaming application 218 can transmit the request to the mobile device. For example, the gaming application 218 can transmit the request to the mobile device via near field communications. The mobile device can receive the request and prompt the current patron to accept the request. As another example, the gaming application 218 can generate a QR code or other scannable code and prompt the current patron to scan the code with their mobile device. Upon scanning the code, the mobile device can receive the request and prompt the patron to accept the request. In some embodiments, the current patron may not be required to accept the request and the mobile device can accept and process the request automatically (e.g., without input from the current patron).

At step 509, the process 500 can include receiving a payload associated with the request. The gaming application 218 can receive the payload associated with the request. After the mobile device receives and accepts the request, the mobile device can transmit the payload to the gaming application 218. In some embodiments, the mobile device can transmit the request to the identification system 212 and the identification system 212 can transmit the payload to the gaming application 218. The gaming application 218 can receive the payload via near field communications or via the network 215. The payload can include information or identity data from the current patron's identification. The payload can include the property.

At step 512, the process 500 can include decrypting the payload to extract the identity data. The gaming application 218 can decrypt the payload to extract the identity data, including the property. The payload can include the nonce from the request. The gaming application 218 can use the nonce provided in the request to decrypt the payload. After decrypting the payload, the gaming application 218 can extract the identity data and determine the property. As discussed with reference to step 309, determining the property associated with the current patron can be patron verification. For example, the property can be the current age of the patron and the gaming application 218 can determine if the current age meets or exceeds a threshold. As another example, the gaming application 218 can determine if the current age of the current patron meets or exceeds the threshold based on the binary (e.g., true/false) response to the request. In another example, the gaming application 218 can verify the identity of the current patron based on the identity data and determine if the current patron has a patron account associated with the gaming system 206.

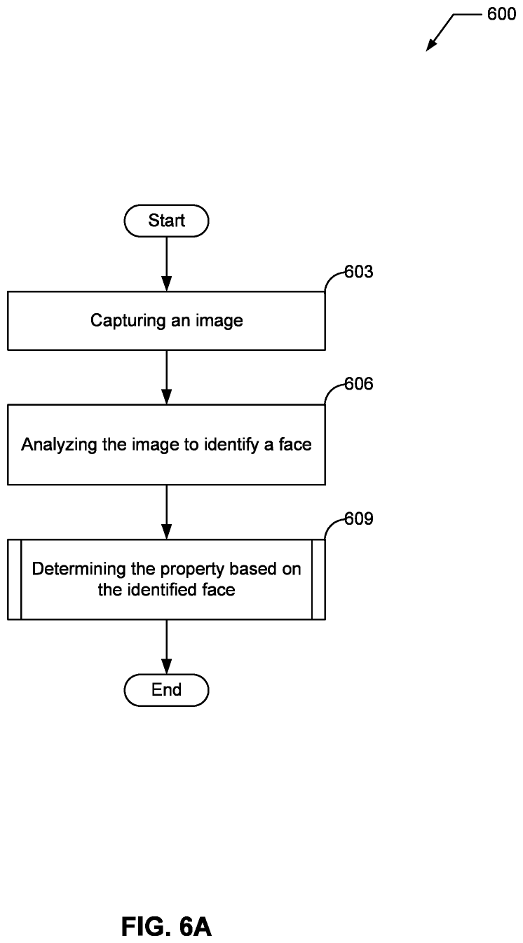

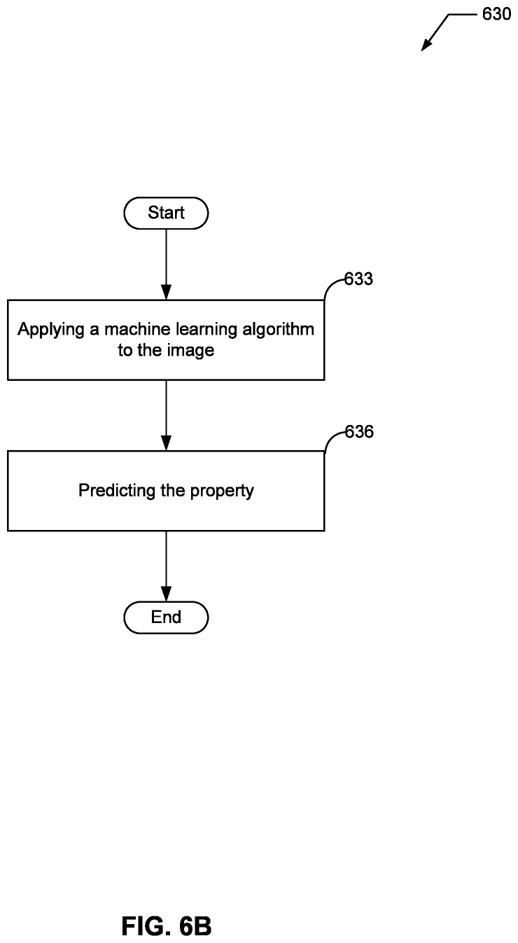

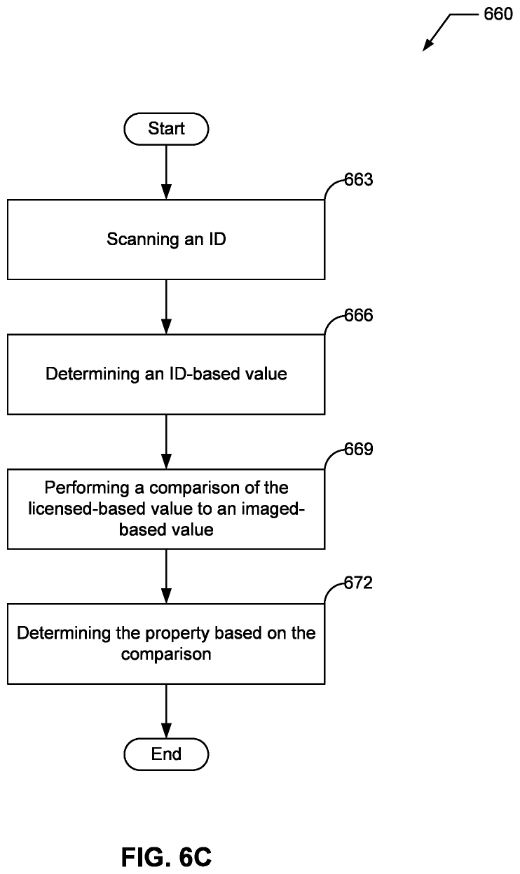

Referring now to FIG. 6A, shown is an exemplary patron verification process 600 according to various embodiments of the present disclosure. Process 600 can be performed entirely, partially, or in coordination with the gaming device 203, the gaming application 218, and the gaming service 242. At step 603, the process 5600 can include capturing an image. The camera 227 can capture the image. The image can be of the current patron. The image can include or primarily feature the current patron's face.

At step 606, the process 600 can include analyzing the image to identify a face. The gaming application 218 can analyze the image to identify a face. The gaming application 218 can apply machine learning algorithms for image recognition. For example, the machine learning algorithms can include, but are not limited to, neural networks, support vector machines, nearest neighbors, random forests, and regression models. The system can train the machine learning algorithms with a set of images including multiple faces with the primary face being identified such that the algorithm can identify the patron in the captured image. The gaming application 218 can identify, from the image, a face belonging to the current patron playing on the gaming device 203. For example, if the image includes the current patron and other patrons in the background, the gaming application 218 can distinguish between the current patron and others patrons based on the location and orientation of the patrons in the image and the distance of the patrons from the gaming device 203.

At step 609, the process 600 can include determining the property based on the identified face. The gaming application 218 can determine the property based on the identified face. For example, the gaming application 218 can determine the property by applying a machine learning algorithm to identified face. As another example, the gaming application 218 can determine the property by comparing the identified face to an identification associated with the current patron. In some embodiments, the gaming application 218 can compare the identified face and/or the identification associated with the current patron to a set patron images in data store 245 for all patrons. For example, a patron may have a photo taken during registration at an entity and the patron's photo may be stored in patron data 248. The gaming service 242 can analyze the identified face, the identification associated with the current patron, and a matching image from patron data 248 to confirm the identity of the patron. Determining an image-based value for the identified face is described further in reference to FIGS. 6B and 6C. As will be understood, the process illustrated by FIGS. 6B and 6C can replace or supplement step 609.

Referring now to FIG. 6B, shown is an exemplary patron verification process 630 according to various embodiments of the present disclosure. Process 630 can be performed entirely, partially, or in coordination with the gaming device 203, the gaming application 218, and the gaming service 242. As will be understood, the process 630 can replace or supplement step 609 in the process 600. At step 633, the process 630 can include applying a machine learning algorithm to the image. The gaming application 218 can apply a machine learning algorithm to the image. For example, the machine learning algorithms can be applied to the identified face or a region of the image representing the face. The image or the identified face can be segmented into regions and a machine learning algorithm can be applied to each region. The machine learning algorithms can include a classification algorithm, including but not limited to neural networks, support vector machines, nearest neighbors, random forests, regression models, ensemble models, and Naive Bayes classifier models. The system can utilize a training data set to train the machine learning algorithms to identify the face or region of the image representing the face. The training data set can include a series of images including previously correctly identified faces, previously incorrectly identified faces, and images omitting any faces along with metadata indicating whether each image was correctly identified, incorrectly identified, or missing a face.

At step 636, the process 630 can include predicting the property. The gaming application 218 can predict the property based on the machine learning algorithms. The system can utilize training data to train the machine learning algorithms to predict the property. The training data can include a set of images depicting faces at various values of the property as well as a respective value for the property for each face. For example, the training data can include images depicting faces at various ages and metadata with the age of the person in each image. The machine learning algorithms can generate a prediction for the property. For example, the machine learning algorithms can predict the current age of the patron or predict whether the current age of the patron meets or exceeds the threshold. As another example, the machine learning algorithms can predict the identity of the current patron. The machine learning algorithms can compare metadata from the patron accounts saved as the patron data 248 to the image or identified face. The patron data 248 can includes images or other identifiers associated with each patron. The machine learning algorithms can compare these images and identifiers to the captured image or identified face to predict the identity of the current patron. In some embodiments, the machine learning algorithm can determine a range of ages within a preconfigured confidence interval for the current patron. In one embodiment, the machine learning algorithm can determine a predictive likelihood score as to whether the patron meets or exceeds the threshold. The gaming application 218 can determine whether the predictive likelihood score meets or exceeds a preset risk threshold.

Referring now to FIG. 6C, shown is an exemplary patron verification process 660 according to various embodiments of the present disclosure. Process 660 can be performed entirely, partially, or in coordination with the gaming device 203, the gaming application 218, and the gaming service 242. As will be understood, the process 660 can replace or supplement step 609 in the process 600. At step 663, the process 660 can include scanning an identification associated with the current patron. The identification can be a scannable device that includes a barcode or other scannable code. For example, the identification can include a driver's license, a government or work issued identification card, a passport, or any other acceptable identification card. The scanner 230 can scan the identification by scanning the barcode or other scannable code included on the identification. The scanner 230 can scan the identification by scanning the identification as an image and performing character recognition on the image. After the scanner 230 scans the identification, the gaming application 218 can determine information included in the identification, including but not limited to, name, age, birthdate, issuer, expiration date, identification number, and address.

At step 666, the process 660 can include determining an identification-based value. The gaming application 218 can determine an identification-based value based on the identification scanned by the scanner 230. For example, the identification-based value can be the current age or birthdate of the current patron. In some embodiments, the gaming application 218 can determine a first value for the property based on analyzing the identification and a second value for the property from a third party service based on a scanned identifier. As an example, the gaming application 218 can analyze the birthdate on the scanned identification to determine a first age and query an identification verification service using information extracted from a bar code on the identification to verify the age of the patron. When the ages match, the gaming application 218 can determine a lower risk score that the patron is determined age. The gaming application 218 can determine the age or birthdate of the current patron listed on the scanned identification. As another example, the identification-based value can be the name of the current patron. The gaming application 218 can determine the name of the current patron listed on the scanned identification. As another example, the identification-based value can be an image of the current patron listed on the identification. The gaming application 218 can determine the image listed on the identification.

At step 669, the process 660 can include performing a comparison of the identification based value to an image-based value. The gaming application 218 can perform a comparison of the identification based value to an image-based value. The image-based value can be any value or data from the image captured at step 603. For example, the image-based value can be the identified face of the current patron from the captured image. The identification-based value can be the image listed on the identification. The gaming application 218 can compare the identified face from the captured image to the image listed on the identification to determine if both images include the same face (e.g., the face of the current patron). If the gaming application 218 determines that the identification-based value matches the image-based value, the gaming application 218 can determined that the scanned identification belongs to the current patron.

At step 672, the process 660 can include determining the property based on the comparison. The gaming application 218 can determine the property based on the comparison performed at step 669. If the gaming application 218 determines that the scanned identification belongs to the patron, the gaming application 218 can determine a value from the identification as the property. For example, the gaming application 218 can determine the current age of the patron based on the birthdate listed on the identification. As another example, the gaming application 218 can determine if the current patron has a patron account with the gaming system 206 based on the name listed on the identification.

As will be understood, processes 400, 500, 600, 630, and 660 can replace, supplement, or expand on the other processes for patron verification. For example, the gaming application 218 can apply some combination of processes 400, 600, and 660 to complete patron verification. As another example, the gaming application 218 can apply some combination of processes 500, 600, and 630 to complete patron verification.

Referring now to FIG. 7, shown is an exemplary lottery ticket generation process 700 according to various embodiments of the present disclosure. Process 700 can be performed entirely, partially, or in coordination with the gaming device 203, the gaming application 218, the gaming service 242, and the lottery system 209. As will be understood, the process 700 can replace or supplement step 312 in the process 300. At step 703, the process 700 can include transmitting a request for an identifier to the lottery system 209. The gaming application 218 or the gaming service 242 can transmit the request for the identifier to the lottery system. For example, prior to the gaming application 218 generating an outcome to a wagering game at step 303, the gaming service 242 can transmit a request for an identifier from the lottery system 209. The gaming service 242 can transmit a request for an identifier from the lottery system 209 prior to, during, or after generating an outcome to a wagering game at step 303. The identifier can include a sequence of numbers, which represent a particular lottery ticket. The identifier can include a predetermined number of digits (e.g., 5 digits, 10 digits, 15 digits).

At step 706, the process 700 can include receiving the identifier from the lottery system. The gaming application 218 or the gaming service 242 can receive the identifier from the lottery system. For example, if the gaming application 218 transmitted the request, the gaming application 218 can receive the identifier. If the gaming service 242 transmitted the request, the gaming service 242 can receive the identifier. The received identifier can be encrypted and include a key for decrypting the identifier. In some embodiments, the gaming application 218 or the gaming service 242 can generate the identifier using a random number generator.

At step 709, the process 700 can include printing the lottery ticket. The lottery ticket can be printed by the gaming system 206 or by the gaming device 203. For example, the gaming system 206 can print the lottery ticket and the lottery ticket can be loaded into the gaming device 203 for later dispensing. As another example, the dispenser 233 can include a printer for printing the lottery ticket. The lottery ticket can any kind of lottery ticket, including a pull tab ticket, a scratch off ticket, and a coin board ticket.

At step 712, the process 700 can include dispensing the lottery ticket. The dispenser 233 can dispense the lottery ticket. The lottery ticket can be dispensed in response to successful patron verification at step 309. The gaming device 203 can include multiple pre-printed lottery tickets and the dispenser 233 can dispense a single ticket at a time. In some embodiments, the gaming device 203 can print and dispense a single lottery ticket at a time.

At step 715, the process 700 can include generating a scannable code. The gaming application 218 can generate the scannable code. The scannable code can include information related to the property. For example, the scannable code can include the name or age of the current patron. The gaming application 218 can display the code on the display 221. The current patron can scan the code using a mobile device. When the current patron validates the lottery ticket at an attendant or kiosk (e.g., redeems the ticket), the attendant or kiosk can request the code and use the code to confirm the identity of the current patron. For example, the attendant or kiosk can use the code to confirm the current age of the patron. As another example, the attendant or kiosk can confirm that the lottery ticket belongs to the current patron.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The processing unit can include one or more hardware processors. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In some embodiments, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein. While thresholds are discussed herein as being met when the threshold is exceeded, the system may determine a threshold is met when a value meets or exceeds the threshold.

Clause 1. A gaming device, comprising: a memory; and at least one computing device in communication with the memory, the at least one computing device being configured to: generate an outcome of a wagering game comprising a plurality of indicia; determine that a particular combination of indicia of the plurality of indicia are positioned along a pay line; in response to a particular combination of indicia positioned along the pay line, determine whether a property associated with a current patron has been verified as meeting or exceeding a threshold; and in response to the property being verified as meeting or exceeding the threshold, provide a lottery ticket to the current patron.

Clause 2. The gaming device of clause 1 or any other clause herein, further comprising a scanner device configured to read an identification, wherein the at least one computing device is further configured to: receive information for the identification for the current patron; verify the identification; determine the property associated with the current patron from the information for the particular identification.

Clause 3. The gaming device of clause 1 or any other clause herein, wherein the at least one computing device is further configured to provide a prize in response to the property not being verified as meeting or exceeding the threshold.

Clause 4. The gaming device of clause 3 or any other clause herein, wherein the prize comprises a toy and the at least one computing device is further configured to dispense the toy to the current patron via a dispensing device.

Clause 5. The gaming device of clause 3 or any other clause herein, wherein the at least one computing device is further configured to: determine that the current patron is not authorized to play the wagering game; and in response to the current patron not being authorized to play the wagering game, restrict access to the wagering game.

Clause 6. The gaming device of clause 1 or any other clause herein, wherein the at least one computing device is further configured to: generate a request for identity data associated with a mobile device; transmit the request to the mobile device; receive a payload associated with the request; and decrypt the payload to extract identity data comprising the property.

Clause 7. The gaming device of clause 1 or any other clause herein, wherein the particular combination of indicia corresponds to a progressive jackpot and the lottery ticket is provided in response to the particular combination causing an award of the progressive jackpot.

Clause 8. A gaming device, comprising: a memory; and at least one computing device in communication with the memory, the at least one computing device being configured to: generate a plurality of outcomes of a wagering game; receive a request to cash out the wagering game; determine that a current credit value is below a threshold; in response to the current credit value falling below the threshold, determine whether a property associated with a current patron has been verified as meeting or exceeding a threshold; and in response to the property being verified as meeting or exceeding the threshold, provide a lottery ticket to the current patron.

Clause 9. The gaming device of clause 8 or any other clause herein, wherein the property comprises an age of the current patron.

Clause 10. The gaming device of clause 8 or any other clause herein, wherein providing the lottery ticket comprises the at least one computing device being configured to: generate a sequence of numbers; print the lottery ticket comprising the sequence of numbers.

Clause 11. The gaming device of clause 10 or any other clause herein, wherein the at least one computing device is further configured to: transmit a request for an identifier from a lottery system, the request comprising the sequence of numbers; and receive the identifier from the lottery system, wherein the lottery ticket comprises the sequence of numbers.

Clause 12. The gaming device of clause 8 or any other clause herein, wherein providing the lottery ticket comprises the at least one computing device being configured to dispense the lottery ticket from a plurality of lottery tickets.

Clause 13. The gaming device of clause 12 or any other clause herein, wherein the lottery ticket comprises at least one of: a pull tab ticket, a scratch off lottery ticket, or a coin board lottery ticket.

Clause 14. A method, comprising: generating, via one of one or more computing devices, a plurality of outcomes of a wagering game; receiving, via one of the one or more computing devices, a request to cash out the wagering game; determining, via one of the one or more computing devices, that a current credit value is below a threshold; in response to the current credit value falling below the threshold, determining, via one of the one or more computing devices, that a property associated with a current patron has been verified as meeting or exceeding a threshold; and in response to the property being verified as meeting or exceeding the threshold, providing, via one of the one or more computing devices, a lottery ticket to the current patron.

Clause 15. The method of clause 14 or any other clause herein, further comprising: receiving, via one of the one or more computing devices, a second request to cash out the wagering game for a second current patron; in response to determining that the current credit value falls below the threshold, determining, via one of the one or more computing devices, that the property associated with the second current patron fails to meet or exceed the threshold; and in response to the property being verified as meeting or exceeding the threshold, providing, via one of the one or more computing devices, a prize to the second current patron.

Clause 16. The method of clause 14 or any other clause herein, further comprising: capturing, via one of the one or more computing devices, an image from a camera; analyzing, via one of the one or more computing devices, the image to identify at least one face represented in the image; and determining, via one of the one or more computing devices, the property of the current patron based on the at least one face identified in the image.

Clause 17. The method of clause 16 or any other clause herein, further comprising applying, via one of one or more computing devices, a machine learning algorithm against a region representing the at least one face in the image to predict an age of the at least one face.

Clause 18. The method of clause 16 or any other clause herein, further comprising: scanning, via one of the one or more computing devices, an identification using a scanning device; determining, via one of the one or more computing devices, an identification-based value for the property of the current patron from information received from the scanning device; performing, via one of the one or more computing devices, a comparison of the identification-based value for the property to an image-based value for the property; and determining, via one of the one or more computing devices, a value of the property of the current patron based the comparison.

Clause 19. The method of clause 14 or any other clause herein, further comprising generating, via one of the one or more computing devices, a scannable code comprising information based on the property, wherein the scannable code is configured to, when scanned while validating the lottery ticket, facilitate confirming the identity of the current patron.

Clause 20. The method of clause 14 or any other clause herein, further comprising: associating, via one of the one or more computing devices, the property with a user account associated with the current patron.

These and other aspects, features, and benefits of the claims will become apparent from the detailed written description of the aforementioned aspects taken in conjunction with the accompanying drawings, although variations and modifications thereto may be effected without departing from the spirit and scope of the novel concepts of the disclosure.

What is claimed is:

1. A gaming device, comprising:
a memory; and
at least one computing device in communication with the memory, the at least one computing device being configured to:
generate an outcome of a wagering game comprising a plurality of indicia;
determine that a particular combination of indicia of the plurality of indicia are positioned along a pay line;
in response to a particular combination of indicia positioned along the pay line, determine whether a property associated with a current patron has been verified as meeting or exceeding a threshold; and
in response to the property being verified as meeting or exceeding the threshold, provide a lottery ticket to the current patron.

2. The gaming device of claim 1, further comprising a scanner device configured to read an identification, wherein the at least one computing device is further configured to:
receive information for the identification for the current patron;
verify the identification;
determine the property associated with the current patron from the information for the particular identification.

3. The gaming device of claim 1, wherein the at least one computing device is further configured to provide a prize in response to the property not being verified as meeting or exceeding the threshold.

4. The gaming device of claim 3, wherein the prize comprises a toy and the at least one computing device is further configured to dispense the toy to the current patron via a dispensing device.

5. The gaming device of claim 3, wherein the at least one computing device is further configured to:
determine that the current patron is not authorized to play the wagering game; and
in response to the current patron not being authorized to play the wagering game, restrict access to the wagering game.

6. The gaming device of claim 1, wherein the at least one computing device is further configured to:
generate a request for identity data associated with a mobile device;
transmit the request to the mobile device;
receive a payload associated with the request; and
decrypt the payload to extract identity data comprising the property.

7. The gaming device of claim 1, wherein the particular combination of indicia corresponds to a progressive jackpot and the lottery ticket is provided in response to the particular combination causing an award of the progressive jackpot.

8. A gaming device, comprising:
a memory; and
at least one computing device in communication with the memory, the at least one computing device being configured to:
generate a plurality of outcomes of a wagering game;
receive a request to cash out the wagering game;
determine that a current credit value is below a threshold;
in response to the current credit value falling below the threshold, determine whether a property associated with a current patron has been verified as meeting or exceeding a threshold; and
in response to the property being verified as meeting or exceeding the threshold, provide a lottery ticket to the current patron.

9. The gaming device of claim 8, wherein the property comprises an age of the current patron.

10. The gaming device of claim 8, wherein providing the lottery ticket comprises the at least one computing device being configured to:
generate a sequence of numbers;
print the lottery ticket comprising the sequence of numbers.

11. The gaming device of claim 10, wherein the at least one computing device is further configured to:
transmit a request for an identifier from a lottery system, the request comprising the sequence of numbers; and
receive the identifier from the lottery system, wherein the lottery ticket comprises the sequence of numbers.

12. The gaming device of claim 8, wherein providing the lottery ticket comprises the at least one computing device being configured to dispense the lottery ticket from a plurality of lottery tickets.

13. The gaming device of claim 12, wherein the lottery ticket comprises at least one of: a pull tab ticket, a scratch off lottery ticket, or a coin board lottery ticket.

14. A method, comprising:
generating, via one of one or more computing devices, a plurality of outcomes of a wagering game;
receiving, via one of the one or more computing devices, a request to cash out the wagering game;
determining, via one of the one or more computing devices, that a current credit value is below a threshold;
in response to the current credit value falling below the threshold, determining, via one of the one or more computing devices, that a property associated with a current patron has been verified as meeting or exceeding a threshold; and
in response to the property being verified as meeting or exceeding the threshold, providing, via one of the one or more computing devices, a lottery ticket to the current patron.

15. The method of claim 14, further comprising:
receiving, via one of the one or more computing devices, a second request to cash out the wagering game for a second current patron;
in response to determining that the current credit value falls below the threshold, determining, via one of the one or more computing devices, that the property associated with the second current patron fails to meet or exceed the threshold; and
in response to the property being verified as meeting or exceeding the threshold, providing, via one of the one or more computing devices, a prize to the second current patron.

16. The method of claim 14, further comprising:
capturing, via one of the one or more computing devices, an image from a camera;
analyzing, via one of the one or more computing devices, the image to identify at least one face represented in the image; and
determining, via one of the one or more computing devices, the property of the current patron based on the at least one face identified in the image.

17. The method of claim 16, further comprising applying, via one of one or more computing devices, a machine learning algorithm against a region representing the at least one face in the image to predict an age of the at least one face.

18. The method of claim 16, further comprising:
scanning, via one of the one or more computing devices, an identification using a scanning device;
determining, via one of the one or more computing devices, an identification-based value for the property of the current patron from information received from the scanning device;
performing, via one of the one or more computing devices, a comparison of the identification-based value for the property to an image-based value for the property; and
determining, via one of the one or more computing devices, a value of the property of the current patron based the comparison.

19. The method of claim 14, further comprising generating, via one of the one or more computing devices, a scannable code comprising information based on the property, wherein the scannable code is configured to, when scanned while validating the lottery ticket, facilitate confirming the identity of the current patron.

20. The method of claim 14, further comprising:
associating, via one of the one or more computing devices, the property with a user account associated with the current patron.
